(19) United States
(12) Patent Application Publication
(10) Pub. No.: US 2015/0346898 A1
(43) Pub. Date: Dec. 3, 2015

(54) High-definition blackboard

(71) Applicant: Andrew Brown, Middletown, NY (US)

(72) Inventor: Andrew Brown, Middletown, NY (US)

(21) Appl. No.: 14/724,844

(22) Filed: May 29, 2015

Related U.S. Application Data
(60) Provisional application No. 62/006,501, filed on Jun. 2, 2014.

(51) Int. Cl. G06F 3/041; G06F 3/16; G09B 5/02; A47B 97/00; F16M 11/04; G06F 3/0488; G06F 3/0354

(52) U.S. Cl. CPC G06F 3/0416; G06F 3/0412; G06F 3/04883; G06F 3/16; G06F 3/03545; A47B 97/001; F16M 11/04; G09B 5/02; G06F 2211/002

(57) ABSTRACT

A high-definition blackboard comprises a tablet-style computer as large as a standard classroom blackboard or dry-erase board, with Universal Service Bus (USB) ports, touch-screen capability, WiFi connectivity to the Internet, an internal disc drive which accommodates DVDs and CD-ROMs, speakers, and a webcam. A multi-purpose pen is provided which may be used as a laser pointer and a wireless mouse, and also serves as a pen for drawing or writing on the visual display of the device, in a manner similar to a conventional blackboard or dry-erase board. Due to the touch-screen capability, the user's bare hand will erase marks made with the pen. The pen may be used to access a digital keyboard which is displayed on the visual display, and may be used to access the Internet or operate conventional programs such as Microsoft® Word®. E-mails may be accessed, typed, and sent, and databases may be accessed, using the digital keyboard.

### CROSS-REFERENCE TO RELATED APPLICATIONS

This Application claims the benefit of U.S. Provisional Application No. 62/006501, filed Jun. 2, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to classroom teaching devices and accessories, and in particular to a high-definition blackboard. Teaching a classroom full of young students becomes more and more challenging every year. They are increasingly tech-savvy and every year, they are more easily bored. Young people have now become accustomed to getting most of their information from the display screen of a laptop, smartphone or tablet, rather than a book or a newspaper. Teaching, and the tools it uses, must keep up with their increasing sophistication and reliance on technology. Providing computers in the classroom is a big step in the right direction, but it is no longer sufficient. A high-definition blackboard, enabling the instructor to provide a varied classroom presentation on a large screen with the material also streaming to the computers on students' desks, would resolve this problem.

### SUMMARY OF THE INVENTION

Accordingly, the invention is directed to a high-definition blackboard. The device comprises a tablet-style computer as large as a standard classroom blackboard or dry-erase board, with Universal Service Bus (USB) ports, touch-screen capability, WiFi connectivity to the Internet, an internal disc drive which accommodates DVDs and CD-ROMs, speakers, and a webcam. A multi-purpose pen is provided which may be used as a laser pointer and a wireless mouse, and also serves as a pen for drawing or writing on the visual display of the device, in a manner similar to a conventional blackboard or dry-erase board. Due to the touch-screen capability, the user's bare hand will erase marks made with the pen. The pen may be used to access a digital keyboard which is displayed on the visual display, and may be used to access the Internet or operate conventional programs such as Microsoft® Word®. E-mails may be accessed, typed, and sent, and databases may be accessed, using the digital keyboard.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the blackboard component of the first exemplary embodiment, displaying the blackboard 10, the visual display 11, the webcam 12, the speakers 13, and the on/off switch 14.

FIG. 2 is a side view of the pen component of the first exemplary embodiment, displaying the pen 15, the tip 15A, and the button 15B.

FIG. 3 is a right side view of the blackboard component of the first exemplary embodiment, displaying the blackboard 10, the DVD drive 16, the USB ports 17, and the SD port 18.

FIG. 4 is a left side view of the blackboard component of the first exemplary embodiment, displaying the blackboard 10, the pen clip 19, and the HDMI port 20.

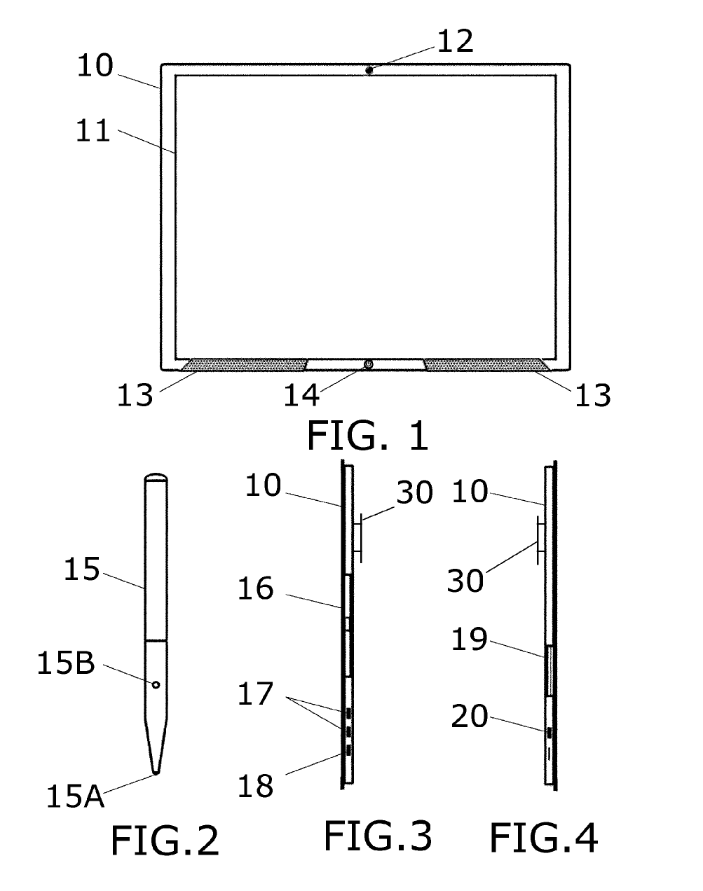

### DETAILED DESCRIPTION OF THE INVENTION

Referring now to the invention in more detail, the invention is directed to a high-definition blackboard 10. The device comprises a tablet-style computer as large as a standard classroom blackboard or dry-erase board, with Universal Service Bus (USB) ports 17, touch-screen capability, wireless fidelity (WiFi) connectivity to the Internet, an internal optical drive 16 such as a DVD drive which accommodates CD-ROMs, speakers 13, and a webcam 12. A multi-purpose pen 15 is provided which may be used as a laser pointer and a wireless mouse, and also serves as a pen for drawing or writing on the visual display 11 of the device, in a manner similar to a conventional blackboard or dry-erase board. Due to the touch-screen capability, the user's bare hand will erase marks made with the pen 15. The pen 15 may be used to access a digital keyboard which is displayed on the visual display 11, and may be used to access the Internet or operate conventional programs such as Microsoft® Word®. E-mails may be accessed, typed, and sent, and databases may be accessed, using the digital keyboard.

The first exemplary embodiment comprises a blackboard 11 which is, in all respects, a very large tablet computer. The front surface provides a large LCD visual display 11 with touch-screen capability, similar in size to a standard blackboard or dry-erase board. The front surface also provides a webcam 12 above the visual display 11, and speakers 13 and an on/off switch 14 below the visual display 11. The right side surface preferably provides a DVD drive 16 which will also accommodate CD-ROMs, a plurality of USB ports 17, and a secure digital (SD) port 18, which will accommodate the SD cards found in many smartphones, digital cameras, and other hand-held devices. The left side surface preferably provides a magnetic pen clip 19 and a high-definition multimedia interface (HDMI) port 20. The blackboard 10 is preferably powered by standard household current.

A multi-purpose pen 15 is also provided. The tip 15A of the pen 15 provides a laser pointer function and is transparent. A button 15B on the side surface of the pen 15 activates the laser light for the laser pointer function. Pressing the tip 15A against the surface of the visual display 11 functions in the same manner as pressing the left button on a conventional mouse. The pen 15 may be used to tap an icon on the visual display, which causes the display of a digital keyboard. The digital keyboard may be used to access the Internet, access and write e-mails, operate conventional computer applications and programs such as Microsoft Word, and access databases. The pen 15 may be secured on the magnetic pen clip 19, and is preferably powered by one or more replaceable batteries.

A mobile application is provided, installed in the blackboard 10 during the manufacturing process, which provides the blackboard function in conjunction with the pen 15. The user may use the application to select a color for the background, such as slate gray, and one or more contrasting colors for any marks made, such as red, white, and bright green. The application may provide a scientific calculator function, such that any mathematical function or equation written on the blackboard 10 will be automatically completed, with the result displayed, when the user taps the visual display twice with the pen 15, operating in the same manner as a double click with a conventional mouse. If insufficient information is provided, the application will display question marks instead of a result.

Electronic components of the invention include the touch screen display 11, the webcam 12, the speakers 13, the on/off switch 14, the pen 15, the DVD drive 16, the USB ports 17, the SD port 18, the HDMI port 20, a microprocessor, a hard drive, and a WiFi transmitter and receiver with internal antenna.

To use the first exemplary embodiment, the user operates the blackboard 10 and pen 15 in the same manner as a tablet computer with pen computing and touch-screen capabilities. The blackboard 10 is preferably configured for writing on the touch screen display 11, erasing writing on the touch screen display 11, displaying a digital keyboard which allows users to type on the screen, accessing the internet, word processing, and mathematical calculations.

The blackboard 10 should also be configured to operate as a blackboard. The user is preferably able to write on the touch screen display 11, erase writing on the touch screen display 11, select the color of the background, select the color of the writing, operate a calculator, perform mathematical calculations, and clear the entire board.

The blackboard 11, the speakers 13, the on/off switch 14, the pen 15, the DVD drive 16, the USB ports 17, the SD port 18, the pen clip 19, the HDMI port 20, the microprocessor, the hard drive, the WiFi transmitter and receiver, and the internal antenna are preferably manufactured from rigid, durable materials such as steel, aluminum alloy, acrylic polymer, and plastic. The visual display 11, the webcam 12, and the tip 15A are preferably manufactured from a rigid, durable material which is transparent, such as acrylic polymer. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A high-definition blackboard, comprising:
(a) a device;
(b) said device having a height of between 3 feet and 4 feet and a width of between 5 feet and 6 feet;
(c) said device having communication ports in electronic communication with said device;
(d) said device having a touch screen display in electronic communication with said device;
(e) said device having wireless connectivity capability;
(f) said device having an internal optical drive in electronic communication with said device;
(g) said device having a secure digital port in electronic communication with said device;
(h) said device having speakers in electronic communication with said device;
(i) said device having an power switch in electronic communication with said device;
(j) said device having a camera in electronic communication with said device;
(k) said camera being located on a display side of said device;
(l) said device having a magnetic pen clip;
(m) said device having a high definition multimedia interface port in electronic communication with said device;
(n) said device having a mount;
(o) a multi-purpose pen;
(p) said multi-purpose pen being configured for registering with said touch screen display of said device;
(q) said device being configured for blackboard display;
(r) said device being configured such that a user may write on said touch screen display;
(s) said device being configured such that a user may erase writing on said touch screen display;
(t) said device being configured such that a user may select different colors for background and writing; and
(u) said device being configured for mathematical calculations;

2. The high-definition blackboard of claim 1, wherein said mount is a wall mount configured for affixing said device on a wall.

3. The high-definition blackboard of claim 1, wherein said mount is a stand mount configured for affixing said device on a stand.

4. The high-definition blackboard of claim 1, wherein, said multi-purpose pen having a tip; said tip providing a laser pointer; said multi-purpose pen having a button; said button activates said laser when pressed.

5. The high-definition blackboard of claim 1, wherein said device being configured for writing on said device with said multipurpose pen.

6. The high-definition blackboard of claim 1, wherein said device being configured for digital keyboard display.

7. The high-definition blackboard of claim 1, wherein said device being configured for internet access.

8. The high-definition blackboard of claim 1, wherein said device being configured for word processing.

9. The high-definition blackboard of claim 1, wherein said device being configured for [symbol]
